(19) United States
(12) Patent Application Publication
(10) Pub. No.: US 2019/0384585 A1
(43) Pub. Date: Dec. 19, 2019

(54) MODIFICATION PACKAGE

(71) Applicant: Microsoft Technology Licensing, LLC, Redmond, WA (US)

(72) Inventors: Sarjana Sheth MITRA, Yarrow Point, WA (US); John James VINTZEL, Redmond, WA (US)

(73) Assignee: Microsoft Technology Licensing, LLC, Redmond, WA (US)

(21) Appl. No.: 16/008,927

(22) Filed: Jun. 14, 2018

(51) Int. Cl. G06F 8/65; G06F 8/61; G06F 9/448

(52) U.S. Cl. CPC G06F 8/65; G06F 3/048; G06F 9/448; G06F 8/61

(57) ABSTRACT

A client computing device, including a processor and non-volatile memory. The non-volatile memory may store instructions that cause the processor to receive an application program package. The application program package may include an application program package binary file and an application program package manifest file. The processor may install the application program package in the non-volatile memory at a file system location indicated in the application program package manifest file. The processor may receive a modification package including a modification package binary file and a modification package manifest file. The modification package manifest file may indicate the file system location. The processor may install the modification package in the non-volatile memory. Installing the modification package may include modifying the application program package binary file and/or the application program package manifest file based on the modification package binary file. The processor may execute the modified application program package binary file.

### BACKGROUND

In existing methods of updating application programs, a single update package is typically written by a developer and transmitted to each computing device on which the application program is installed. Such methods of updating an application program typically do not allow for customization of features of the application program that persist between updates. For example, if a network administrator makes customizations to the application program for users of the application program on a network, such customizations may be incompatible with, or may be overwritten by, future updates to the application program that are written by the developer of the application program. This can cause potential frustration to the network administrator and/or users, who may be required to further configure their application program installations after such updates.

### SUMMARY

According to one aspect of the present disclosure, a client computing device is provided, including a processor and non-volatile memory. The non-volatile memory may store instructions that when executed by the processor cause the processor to receive an application program package. The application program package may include an application program package binary file and an application program package manifest file. The instructions may further cause the processor to install the application program package in the non-volatile memory at a file system location indicated in the application program package manifest file. The instructions may further cause the processor to receive a modification package including a modification package binary file and a modification package manifest file. The modification package manifest file may indicate the file system location of the application program package in the non-volatile memory. The instructions may further cause the processor to install the modification package in the non-volatile memory. Installing the modification package may include modifying the application program package binary file and/or the application program package manifest file based on at least one setting included in the modification package binary file. The instructions may further cause the processor to execute the modified application program package binary file.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example client computing device, according to one embodiment of the present disclosure.

FIG. 2 shows an example of an application program window included in a graphical user interface, according to the embodiment of FIG. 1.

FIG. 3 shows an example of a modification package window included in a graphical user interface, according to the embodiment of FIG. 1.

FIG. 4 shows the client computing device of FIG. 1 in an example embodiment in which the processor is configured to receive an additional modification package, according to the embodiment of FIG. 1.

FIG. 5 shows an example modification structure for an application program package, according to the embodiment of FIG. 1.

FIG. 6 shows a schematic view of an example server computing device, according to the embodiment of FIG. 1.

FIG. 7 shows the server computing device of FIG. 6 in an example embodiment in which the processor is configured to generate an additional modification package.

FIG. 8A shows a flowchart of an example method that may be performed at a client computing device, according to the embodiment of FIG. 1.

FIGS. 8B and 8C show additional steps that may optionally be performed as part of the method of FIG. 8A.

FIG. 9 shows a schematic representation of an example computing system, according to one embodiment of the present disclosure.

### DETAILED DESCRIPTION

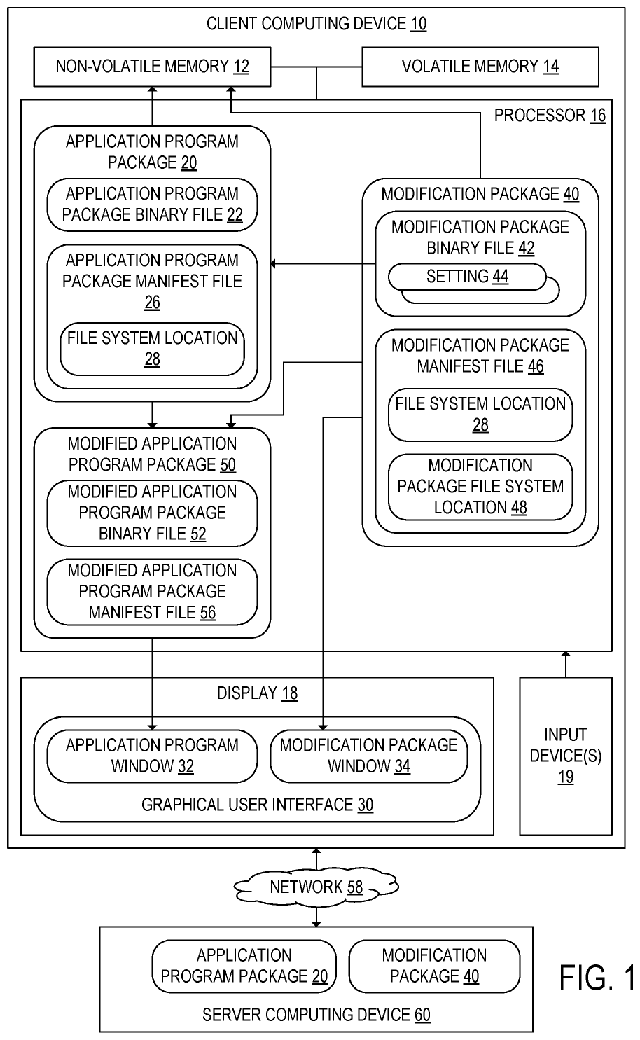

In order to address the difficulties discussed above, a client computing device 10 is provided, as shown in FIG. 1. The client computing device 10 may include non-volatile memory 12 and may further include volatile memory 14. The client computing device 10 may further include a processor 16 operatively coupled to the non-volatile memory 12. In some embodiments, the client computing device 10 may further include a display 18 configured to display a graphical user interface (GUI) 30. The client computing device 10 may additionally or alternatively include other output devices, such as one or more speakers or haptic feedback devices. In some embodiments, the client computing device 10 may further include one or more input devices 19, which may include one or more of a touchscreen, a keyboard, a trackpad, a mouse, a button, a microphone, a camera, and/or an accelerometer. Other types of input devices 19 and/or output devices may be included in some embodiments of the client computing device 10.

The processor 16 of the client computing device 10 may be configured to receive an application program package 20. In some embodiments, the application program package 20 may be received via a network 58 from a server computing device 60. The server computing device 60 may host an application program store from which a user may purchase application programs. In some embodiments, prior to receiving the application program package 20, the processor 16 may receive an authentication certificate from the server computing device 60 in order to verify that the server computing device 60 is a trusted application program publisher.

The application program package 20 may include an application program package binary file 22 and an application program package manifest file 26. The application program package binary file 22 may include one or more binary instructions configured to be executed by the processor 16 in order to run an application program. In some embodiments, the application program package 20 may include a plurality of application program package binary files 22. The application program package manifest file 26 may include metadata associated with the application program package 20. This metadata may include a file system location 28 at which the application program package binary file 22 is configured to be installed. The file system location 28 may be a directory path. In some embodiments, rather than being included in the application program package manifest file 26, the file system location 28 may be specified by a package family name included in the application program package 20.

In embodiments in which the application program package 20 includes a plurality of application program package binary files 22, the application program package manifest file 26 may include a file system location 28 for each application program package binary file 22.

The application program package manifest file 26 may further include other properties of the application program package 20, such as an entry point that specifies one or more conditions under which to launch the application program. As another example, the application program package manifest file 26 may include an application program icon indicating the application program in the GUI 30.

The processor 16 may be further configured to install the application program package 20 in the non-volatile memory 12 at the file system location 28 indicated in the application program package manifest file 26. Alternatively, in embodiments in which the file system location 28 of the application program package 20 is indicated by a package family name, the processor 16 may be further configured to install the application program package 20 in the non-volatile memory 12 at the file system location 28 based on the package family name.

In embodiments in which the application program package 20 includes a plurality of application program package binary files 22, each application program package binary file 22 may be installed at the respective file system location 28 indicated for that application program package binary file 22 in the application program package manifest file 26.

The application program package manifest file 26 may further include other data based on which the application program package may be installed. For example, the application program package manifest file 26 may indicate access permissions for the application program.

The processor 16 may be further configured to receive a modification package 40. Similarly to the application program package 20, the modification package 40 may be received via the network 58 from an application program store. The modification package 40 may include a modification package binary file 42 and a modification package manifest file 46. The modification package binary file 42 may be a modification to the functionality of the application program package binary file 22. For example, the modification package binary file 42 may be a plugin that is launched in addition to the application program package binary file 22 whenever the application program package binary file 22 is executed.

The modification package manifest file 46 may indicate the file system location 28 of the application program package 20 in the non-volatile memory 12 of the client computing device 10. In some embodiments, rather than including the file system location 28 in the modification package manifest file 46, the modification package 40 may include one or more instructions to receive the file system location 28 via an application program interface (API) executed by the processor 16. In such embodiments, the modification package may receive a package family name of the application program package 20. The processor 16 may be further configured to update the modification package 40 via the API in response to a change in the file system location 28 of the application program package 20. Thus, the processor 16 may allow the modification package binary file 42 to modify the application program package binary file 22 even if the application program package 20 is moved to a different file system location 28.

In embodiments in which the application program package 20 includes a plurality of application program package binary files 22 with a plurality of respective file system locations 28, the modification package manifest file 46 may indicate the respective file system location 28 of each application program package binary file 22. In addition, the modification package manifest file 46 may indicate a modification package file system location 48 at which the modification package 40 is configured to be installed in the non-volatile memory 12. The modification package manifest file 46 may further include other installation settings for the modification package 40. For example, the modification package manifest file 46 may specify one or more conditions under which the modification package binary file 42 is executed.

The processor 16 may be further configured to install the modification package 40 in the non-volatile memory 12. In some embodiments, the processor 16 may install the modification package binary file 42 at an administrative level. Installing the modification package 40 may include modifying the application program package binary file 22 and/or the application program package manifest file 26 based on at least one setting 44 included in the modification package binary file 42. For example, the at least one setting 44 may add a plugin to the application program. As another example, the at least one setting 44 may change the application program icon that indicates the application program in the GUI 30. In some embodiments, the modification package binary file 42 may include a plurality of settings 44 based on which the application program package binary file 22 and/or the application program package manifest file 26 may be modified. In some embodiments, a plurality of application program package binary files 22 may be modified based on the at least one setting 44. Installing the modification package 40 may include generating a modified application program package 50, which may include a modified application program package binary file 52 and/or a modified application program package manifest file 56. In some embodiments, the modified application program package binary file 52 may be the modification package binary file 42.

In some embodiments, the processor 16 may be further configured to provide the user with an option to uninstall the modification package 40. In embodiments in which the computing device is configured to display a GUI 30 on a display 18, the option to uninstall the modification package 40 may be provided at the GUI 30. In response to a selection of the option, the processor 16 may be further configured to uninstall the modification package 40.

After the modification package 40 has been installed, the processor 16 may be further configured to execute the modified application program package binary file 52. Thus, a user may access an updated version of the application program. In embodiments in which the modified application program package binary file 52 is the modification package binary file 42, executing the modified application program package binary file 52 may include executing the modification package binary file 42 in place of the application program package binary file 22. In such embodiments, the modification package 40 may be installed at runtime by replacing the application program package binary file 22 with the modification package binary file 42.

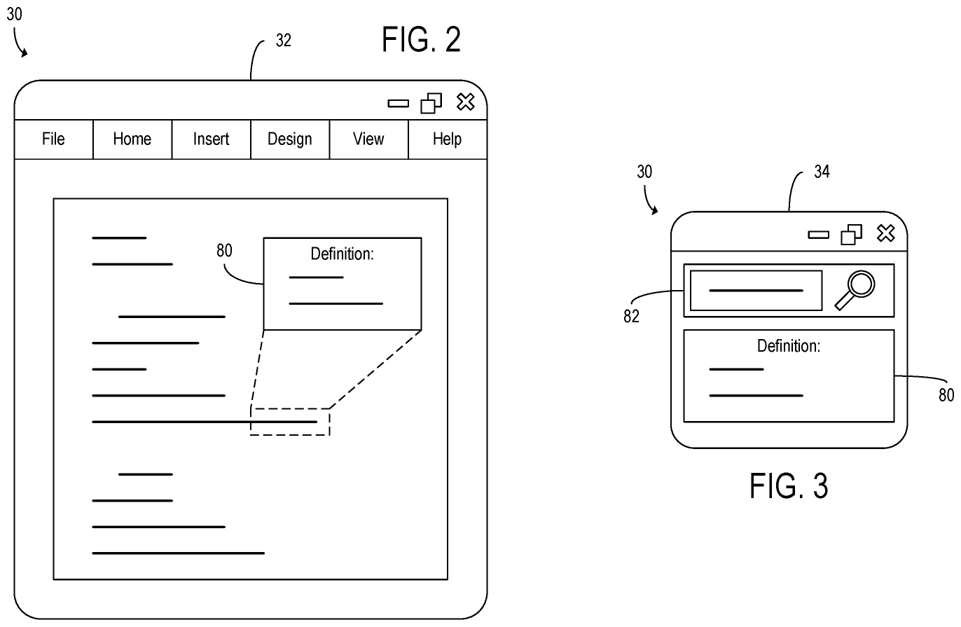

In some embodiments, the processor 16 may be further configured to output an application program window 32 for display at the GUI 30 when the modified application program package binary file 52 is executed. An example application program window 32 is shown in FIG. 2. In the example of FIG. 2, the application program is a word processing application program to which the modification package 40 adds a dictionary plugin. A modification package GUI element 80 that indicates a definition of a word included in a document open in the word processing application program is shown in the application program window 32.

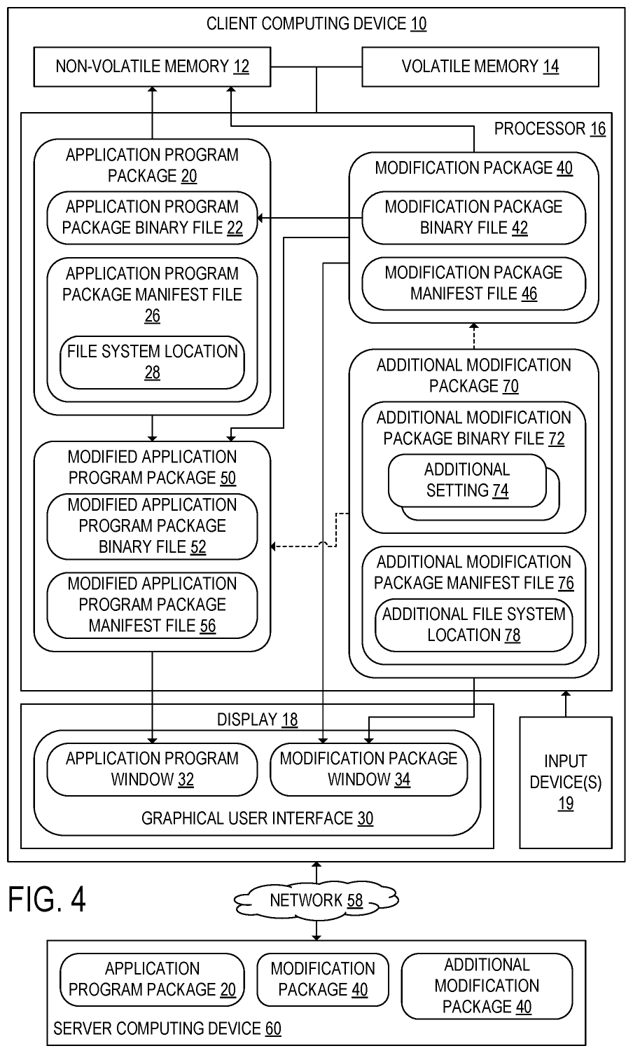

In some embodiments, the processor 16 may be further configured to execute the modification package binary file 42 independently of the modified application program package binary file 52. Thus, the modification package binary file 42 may be run as an independent application program in addition to or instead of as a modification to the application program. In such embodiments, processor 16 may be further configured to output a modification package window 34 for display at the GUI 30 when the modification package binary file 42 is executed independently of the modified application program package binary file 52. In some embodiments, the modification package window 34 includes one or more GUI elements not included in the application program window 32 when the modified application program package binary file 52 is executed. FIG. 3 shows an example modification package window 34 according to the embodiment of FIG. 2. Similarly to the application program window 32, the modification package window 34 of FIG. 3 includes a modification package GUI element 80 that indicates a definition of a word. In addition, the modification package window 34 includes a search bar 82 at which the user may enter a word to define.

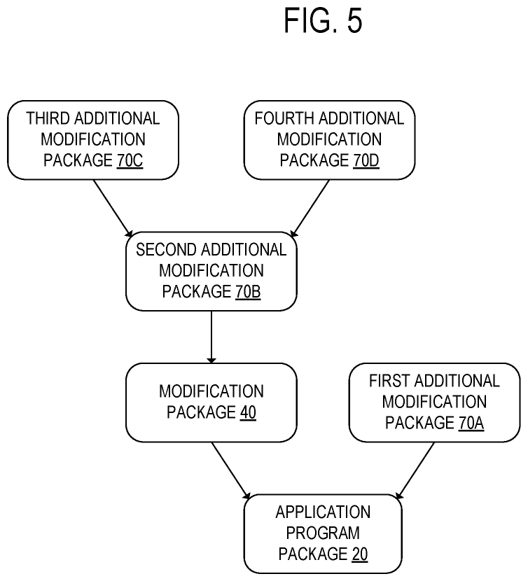

In some embodiments, as shown with respect to FIG. 4, the processor 16 may be further configured to receive an additional modification package 70 including an additional modification package binary file 72 and an additional modification package manifest file 76. In such embodiments, the processor 16 may be further configured to modify the modified application program package binary file 52 and/or the modified application program package manifest file 56 based on at least one additional setting 74 included in the additional modification package binary file 72. The additional modification package manifest file 76 may include an additional file system location 78 at which the additional modification package 70 is configured to be installed. The additional modification package manifest file 76 may further include the file system location 28 of the application program package 20 and/or the modification package file system location 48 of the modification package 40.

The additional modification package 70 may be installed based at least in part on the modification package binary file 42 and/or the modification package manifest file 46. Thus, the additional modification package 70 may be installed such that changes made to the application program package 20 by the modification package 40 and the additional modification package 70 do not conflict with each other. In other embodiments, changes made by the modification package 40 or the additional modification package 70 may be prioritized.

In some embodiments, additionally or alternatively to modifying the modified application program package 50, the processor 16 may be further configured to modify the modification package binary file 42 and/or the modification package manifest file 46 based on the at least one additional setting 74 included in the additional modification package binary file 72. Thus, the user may apply an update to a modification package 40 that has previously been installed. For example, a network administrator may apply the at least one additional setting 74 on client computing devices 10 that have installed the modification package 40, but not on client computing devices 10 on which the application program package 20 remains unmodified. Such customizability may be useful, for example, when fixing errors in a modification package 40 that is not used by all users of the application program in the network 58.

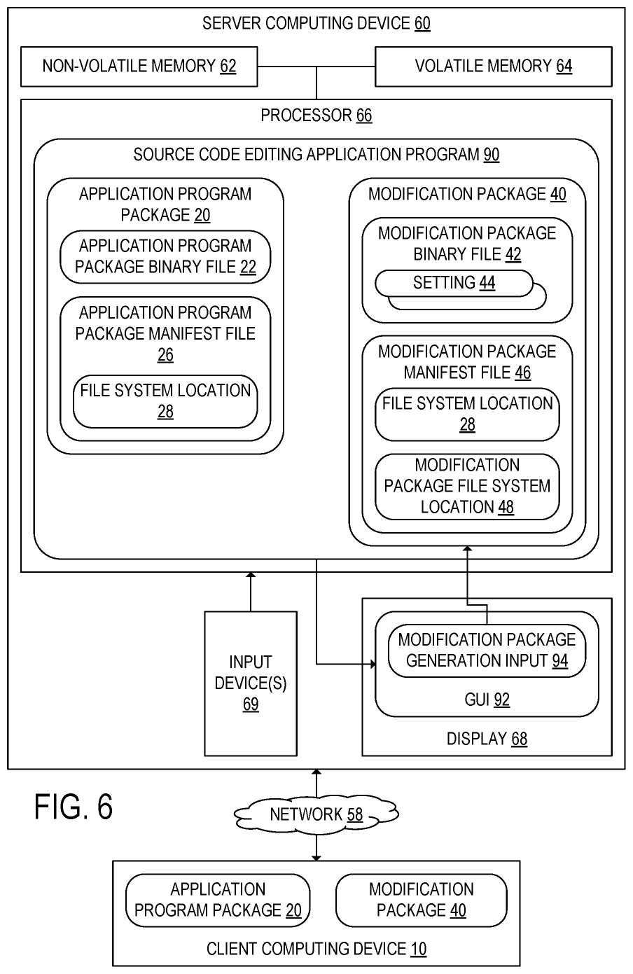

Similarly to the modification package binary file 42, the additional modification package binary file 72 may be run as a standalone application program. In some embodiments, the modification package binary file 42 may be executed independently from the application program package binary file 22 after having been modified by the additional modification package binary file 72. Modified application programs may be assembled in a modular manner from a plurality of packages, as shown in FIG. 5. In the example of FIG. 5, an application program package 20 is modified by a modification package 40 and a first additional modification package 70A. The modification package 40 is in turn modified by a second additional modification package 70B, which is modified by a third additional modification package 70C and a fourth additional modification package 70D. Some or all of the modification package 40, the first additional modification package 70A, the second additional modification package 70B, the third additional modification package 70C, and the fourth additional modification package 70D may be configured to be executed independently of the respective packages they modify. The structure shown in FIG. 5 is only one example structure of package modification that may be formed using one or more application program packages 20, modification packages 40, and/or additional modification packages 70. More generally, the structure of package modification may be any directed acyclic graph.

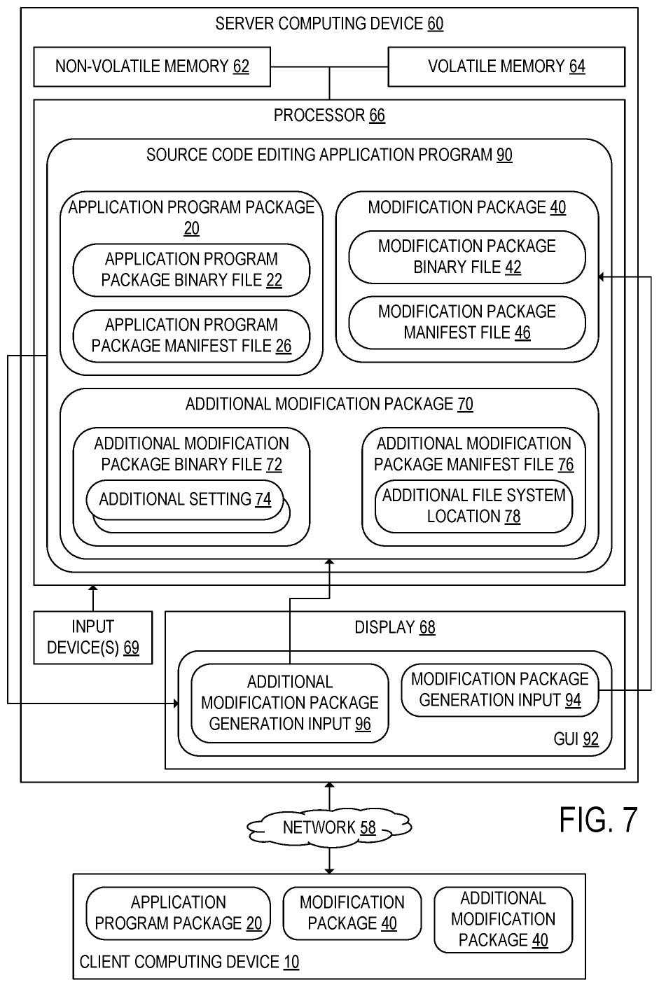

FIG. 6 schematically shows the server computing device 60 of FIG. 1 in further detail. The server computing device 60 as shown in FIG. 6 may include non-volatile memory 62 and volatile memory 64, which may be operatively coupled to a processor 66. The server computing device 60 may further include one or more input devices 69. In addition, the server computing device 60 may include a display 68 and/or one or more other output devices. In some embodiments, the functions performed by the server computing device 60 may be divided between a plurality of communicatively coupled server computing devices 60.

The processor 66 may be configured to execute a source code editing application program 90 that may allow a user of the server computing device 60 to write and modify source code. In embodiments in which the server computing device 60 includes a display 68, the display 68 may be configured to display a GUI 92 of the source code editing application program 90. The GUI 92 may, for example, include an editor window.

The processor 66 of the server computing device 60 may be configured to transmit an application program package 20 to a client computing device 10 via a network 58. As discussed above with reference to FIG. 1, the application program package 20 may include an application program package binary file 22. The application program package 20 may further include an application program package manifest file 26 that indicates a file system location 28 in the non-volatile memory 12 of the client computing device 10 at which to store the application program package 20. In some embodiments, the application program package 20 may include a plurality of application program package binary files 22 and corresponding file system locations 28. The application program package manifest file 26 may further include other metadata associated with the application program package 20.

In embodiments in which the server computing device 60 includes a display 68 configured to display a GUI 92 of a source code editing application program 90, the application program package 20 may be generated based on one or more user inputs interacting with the GUI 92, for example, at the editor window. In such embodiments, the one or more inputs may be received via an input device 69 of the one or more input devices 69.

The processor 66 of the server computing device 60 may be further configured to receive a modification package generation input 94. The modification package generation input 94 may be an input received via an input device 69 of the one or more input devices 69. In embodiments in which the server computing device includes a display 68 configured to display a GUI 92 of a source code editing application program 90, the modification package generation input 94 may be an interaction with one or more GUI elements included in the GUI 92.

Based on the modification package generation input 94, the processor 66 may be further configured to generate a modification package 40 including a modification package binary file 42 and a modification package manifest file 46. The modification package binary file 42 may include one or more instructions to modify the application program package binary file 22 and/or the application program package manifest file 26. The one or more instructions may include the at least one setting 44 based on which the application program package binary file 22 may be modified, as discussed above with reference to FIG. 1. In some embodiments, the modification package 40 may include a plurality of modification package binary files 42. The modification package manifest file 46 may indicate the file system location 28 of the application program package 20. In some embodiments, the modification package manifest file 46 may further include a modification package file system location 48 at which the modification package is configured to be installed in the non-volatile memory 62 of the server computing device 60. In some embodiments, the modification package binary file 42 may be generated such that it is configured to be executable by the client computing device 10 independently of the application program package binary file 22.

The processor 66 may be further configured to transmit the modification package 40 to the client computing device 10 via the network 58.

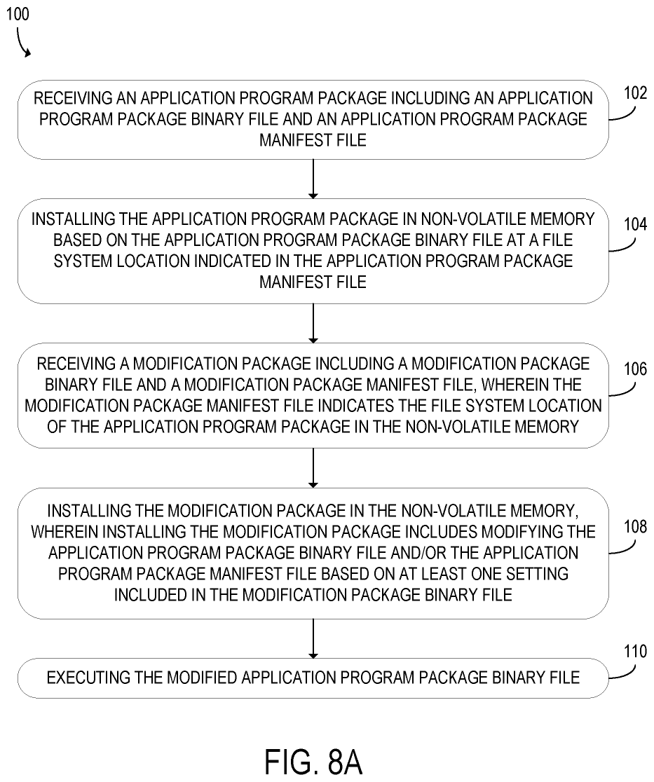

As shown in FIG. 7, the processor 66 of the server computing device 60 may, in some embodiments, be further configured to receive an additional modification package generation input 96. Similarly to the modification package generation input 94, the additional modification package generation input 96 may be received at the GUI 92 of the source code editing application program 90 via an input device 69 of the one or more input devices 69.

In response to receiving the additional modification package generation input 96, the processor 66 may be further configured to generate an additional modification package 70. The additional modification package 70 may include an additional modification package binary file 72, which may include one or more additional instructions to modify at least one of the modified application program package binary file 52, the modified application program package manifest file 56, the modification package binary file 42, and the modification package manifest file 46. The one or more instructions may include one or more additional settings 74 based on which the processor 16 of the client computing device 10 may be configured to perform such a modification.

The additional modification package 70 may further include an additional modification package manifest file 76. The additional modification package manifest file 76 may include an additional file system location 78 at which the additional modification package 70 is configured to be installed in the non-volatile memory 12 of the client computing device 10. The additional modification package manifest file 76 may further indicate the file system location 28 of the application program package 20 and/or the modification package file system location 48 of the modification package 40.

The processor 66 of the server computing device 60 may be further configured to transmit the additional modification package 70 to the client computing device 10 via the network 58.

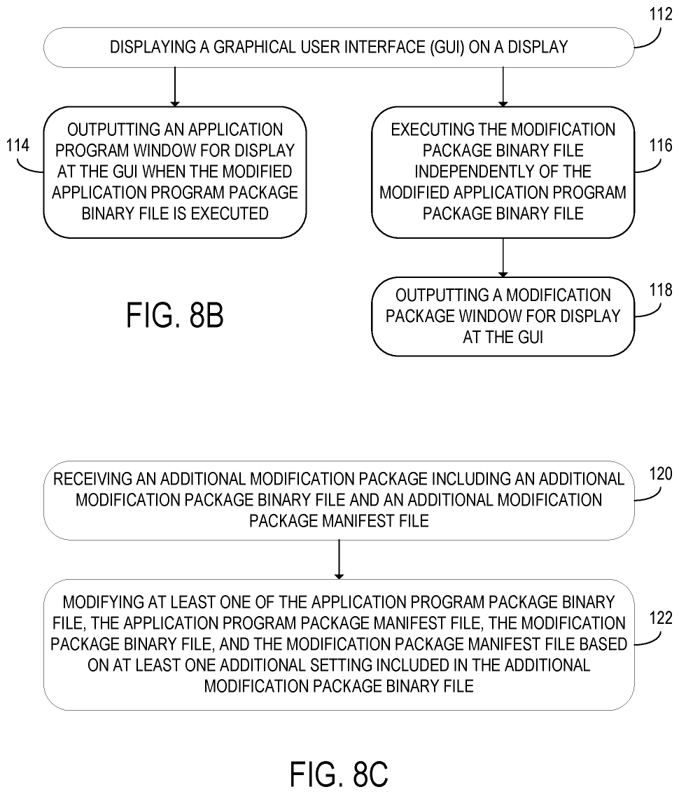

FIG. 8A shows a flowchart of an example method 100 that may be performed at a client computing device. The method 100 may be performed at the client computing device 10 depicted in FIG. 1. At step 102, the method 100 may include receiving an application program package including an application program package binary file and an application program package manifest file. In some embodiments, the application program package may include a plurality of application program package binary files. The application program package may be received via a network from a server computing device. At step 104, the method 100 may further include installing the application program package in non-volatile memory at a file system location indicated in the application program package manifest file.

At step 106, the method 100 may further include receiving a modification package including a modification package binary file and a modification package manifest file. The modification package may be received via the network from the server computing device. One or both of the application program package and the modification package may be received via the network from an application program store. The modification package binary file may include one or more instructions configured to be executed by the processor. The instructions may include at least one setting of the application program package that the modification package binary file may modify. The modification package manifest file may indicate the file system location of the application program package in the non-volatile memory and may further include a modification package file system location at which the modification package is configured to be stored in the non-volatile memory.

At step 108, the method 100 may further include installing the modification package in the non-volatile memory. Installing the modification package may include modifying the application program package binary file and/or the application program package manifest file based on the at least one setting included in the modification package binary file. At step 110, the method 100 may further include executing the modified application program package binary file.

FIGS. 8B and 8C show additional steps that may optionally be performed as part of the method 100. FIG. 8B shows step 112, at which the method 100 may include display a GUI on a display. The display may be included in the client computing device. At step 114, the method 100 may further include outputting an application program window for display at the GUI when the modified application program package binary file is executed. Additionally or alternatively to step 114, the method 100 may further include, at step 116, executing the modification package binary file independently of the modified application program package binary file. In some embodiments, the modification package binary file may be executed independently of the modified application program package binary file even when a GUI is not displayed. When the modification package binary file is executed independently of the modified application program package binary file, the method 100 may further include, at step 116, outputting a modification package window for display at the GUI. Thus, the modification package binary file may be launched as a separate application from the application program.

As shown in FIG. 8C, the method 100 may further include, at step 120, receiving an additional modification package including an additional modification package binary file and an additional modification package manifest file. In response to receiving the additional modification package, the method 100 may further include, at step 122, modifying at least one of the modified application program package binary file, the modified application program package manifest file, the modification package binary file, and the modification package manifest file based on at least one additional setting included in the additional modification package binary file. In some embodiments, a plurality of additional modifications may be applied to the application program package and/or the modification package.

In some embodiments, the methods and processes described herein may be tied to a computing system of one or more computing devices. In particular, such methods and processes may be implemented as a computer-application program or service, an application-programming interface (API), a library, and/or other computer-program product.

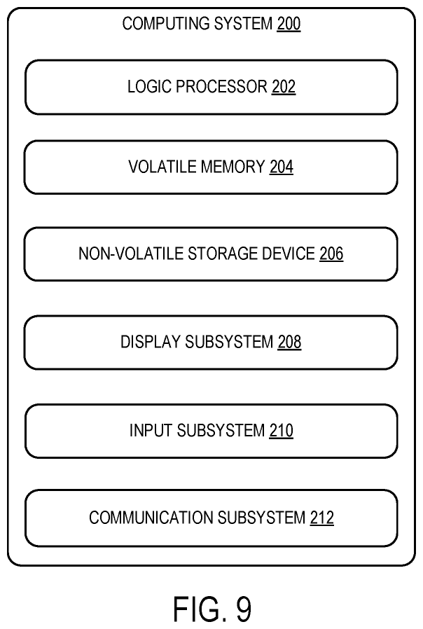

FIG. 9 schematically shows a non-limiting embodiment of a computing system 200 that can enact one or more of the methods and processes described above. Computing system 200 is shown in simplified form. Computing system 200 may embody the client computing device 10 described above and illustrated in FIG. 1. Computing system 200 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 9.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FP GAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 200 to send and/or receive messages to and/or from other devices via a network such as the Internet.

According to one aspect of the present disclosure, a client computing device is provided, including a processor and non-volatile memory. The non-volatile memory may store instructions that when executed by the processor cause the processor to receive an application program package including an application program package binary file and an application program package manifest file. The instructions may further cause the processor to install the application program package in the non-volatile memory at a file system location indicated in the application program package manifest file. The instructions may further cause the processor to receive a modification package including a modification package binary file and a modification package manifest file. The modification package manifest file may indicate the file system location of the application program package in the non-volatile memory. The instructions may further cause the processor to install the modification package in the non-volatile memory. Installing the modification package includes modifying the application program package binary file and/or the application program package manifest file based on at least one setting included in the modification package binary file. The instructions may further cause the processor to execute the modified application program package binary file.

According to this aspect, the client computing device may further include a display configured to display a graphical user interface (GUI). The non-volatile memory may further include instructions that when executed by the processor further cause the processor to output an application program window for display at the GUI when the modified application program package binary file is executed.

According to this aspect, the non-volatile memory may further include instructions that when executed by the processor further cause the processor to execute the modification package binary file independently of the modified application program package binary file.

According to this aspect, the non-volatile memory may further include instructions that when executed by the processor further cause the processor to output a modification package window for display at the GUI when the modification package binary file is executed independently of the modified application program package binary file.

According to this aspect, at least one of the application program package and the modification package may be received via a network from an application program store.

According to this aspect, the non-volatile memory may further include instructions that when executed by the processor further cause the processor to receive an additional modification package including an additional modification package binary file and an additional modification package manifest file.

According to this aspect, the non-volatile memory may further include instructions that when executed by the processor further cause the processor to modify the modified application program package binary file and/or the modified application program package manifest file based on at least one additional setting included in the additional modification package binary file.

According to this aspect, the non-volatile memory may further include instructions that when executed by the processor further cause the processor to modify the modification package binary file and/or the modification package manifest file based on at least one additional setting included in the additional modification package binary file.

According to this aspect, the modification package manifest file may further indicate a modification package file system location at which the modification package is configured to be installed in the non-volatile memory.

According to this aspect, the non-volatile memory may further include instructions that when executed by the processor further cause the processor to install the modification package binary file at an administrative level.

According to another aspect of the present disclosure, a server computing device is provided, including a processor and non-volatile memory. The non-volatile memory may store instructions that when executed by the processor cause the processor to transmit an application program package to a client computing device via a network. The application program package may include an application program package binary file. The application program package may further include an application program package manifest file that indicates a file system location in non-volatile memory of the client computing device at which to store the application program package. The instructions may further cause the processor to receive a modification package generation input. The instructions may further cause the processor to generate a modification package including a modification package binary file and a modification package manifest file. The modification package binary file may include one or more instructions to modify the application program package binary file and/or the application program package manifest file. The modification package manifest file may further indicate the file system location of the application program package. The instructions may further cause the processor to transmit the modification package to the client computing device via the network.

According to this aspect, the modification package binary file may be configured to be executable independently of the application program package binary file.

According to this aspect, wherein the non-volatile memory may further include instructions that when executed by the processor further cause the processor to receive an additional modification package generation input. The instructions may further cause the processor to generate an additional modification package including an additional modification package binary file and an additional modification package manifest file. The instructions may further cause the processor to transmit the additional modification package to the client computing device.

According to this aspect, the additional modification package binary file may include one or more additional instructions to modify at least one of the modified application program package binary file, the modified application program package manifest file, the modification package binary file, and the modification package manifest file.

According to this aspect, the server computing device may further include a display configured to display a graphical user interface (GUI) of a source code editing application program. The non-volatile memory further may include instructions that when executed by the processor further cause the processor to receive the modification package generation input via the GUI of the source code editing application program.

According to another aspect of the present disclosure, a method performed at a client computing device is provided. The method may include receiving an application program package including an application program package binary file and an application program package manifest file. The method may further include installing the application program package in non-volatile memory at a file system location indicated in the application program package manifest file. The method may further include receiving a modification package including a modification package binary file and a modification package manifest file. The modification package manifest file may indicate the file system location of the application program package in the non-volatile memory. The method may further include installing the modification package in the non-volatile memory. Installing the modification package may include modifying the application program package binary file and/or the application program package manifest file based on at least one setting included in the modification package binary file. The method may further include executing the modified application program package binary file.

According to this aspect, the method may further include executing the modification package binary file independently of the modified application program package binary file.

According to this aspect, at least one of the application program package and the modification package may be received via a network from an application program store.

According to this aspect, the method may further include receiving an additional modification package including an additional modification package binary file and an additional modification package manifest file.

According to this aspect, the method may further include modifying at least one of the modified application program package binary file, the modified application program package manifest file, the modification package binary file, and the modification package manifest file based on at least one additional setting included in the additional modification package binary file.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A client computing device comprising:
a processor and non-volatile memory storing instructions that when executed by the processor cause the processor to:
receive an application program package including an application program package binary file and an application program package manifest file;
install the application program package in the non-volatile memory at a file system location indicated in the application program package manifest file;
receive a modification package including a modification package binary file and a modification package manifest file, wherein the modification package manifest file indicates the file system location of the application program package in the non-volatile memory;
install the modification package in the non-volatile memory, wherein installing the modification package includes modifying at least one of the application program package binary file or the application program package manifest file based on at least one setting included in the modification package binary file;
execute the modified application program package binary file; and
execute the modification package binary file independently of the modified application program package binary file.

2. The client computing device of claim 1, further comprising a display configured to display a graphical user interface (GUI), wherein the non-volatile memory further includes instructions that when executed by the processor further cause the processor to output an application program window for display at the GUI when the modified application program package binary file is executed.

3. (canceled)

4. The client computing device of claim 2, wherein the non-volatile memory further includes instructions that when executed by the processor further cause the processor to output a modification package window for display at the GUI when the modification package binary file is executed independently of the modified application program package binary file.

5. The client computing device of claim 1, wherein at least one of the application program package and the modification package is received via a network from an application program store.

6. The client computing device of claim 1, wherein the non-volatile memory further includes instructions that when executed by the processor further cause the processor to receive an additional modification package including an additional modification package binary file and an additional modification package manifest file.

7. The client computing device of claim 6, wherein the non-volatile memory further includes instructions that when executed by the processor further cause the processor to modify the modified application program package binary file and/or the modified application program package manifest file based on at least one additional setting included in the additional modification package binary file.

8. The client computing device of claim 6, wherein the non-volatile memory further includes instructions that when executed by the processor further cause the processor to modify the modification package binary file and/or the modification package manifest file based on at least one additional setting included in the additional modification package binary file.

9. The client computing device of claim 1, wherein the modification package manifest file further indicates a modification package file system location at which the modification package is configured to be installed in the non-volatile memory.

10. The client computing device of claim 1, wherein the non-volatile memory further includes instructions that when executed by the processor further cause the processor to install the modification package binary file at an administrative level.

11. A server computing device, comprising:
a processor and non-volatile memory storing instructions that when executed by the processor cause the processor to:
transmit an application program package to a client computing device via a network, wherein the application program package includes:
an application program package binary file; and
an application program package manifest file that indicates a file system location in non-volatile memory of the client computing device at which to store the application program package;
receive a modification package generation input;
generate a modification package including a modification package binary file and a modification package manifest file, wherein:
the modification package binary file includes one or more instructions to modify at least one of the application program package binary file or the application program package manifest file;
the modification package manifest file indicates the file system location of the application program package; and
the modification package binary file being executable independently of the application program package binary file; and
transmit the modification package to the client computing device via the network.

12. (canceled)

13. The server computing device of claim 11, wherein the non-volatile memory further includes instructions that when executed by the processor further cause the processor to:
receive an additional modification package generation input;
generate an additional modification package including an additional modification package binary file and an additional modification package manifest file; and
transmit the additional modification package to the client computing device.

14. The server computing device of claim 13, wherein the additional modification package binary file includes one or more additional instructions to modify at least one of the modified application program package binary file, the modified application program package manifest file, the modification package binary file, and the modification package manifest file.

15. The server computing device of claim 11, further comprising a display configured to display a graphical user interface (GUI) of a source code editing application program, wherein the non-volatile memory further includes instructions that when executed by the processor further cause the processor to receive the modification package generation input via the GUI of the source code editing application program.

16. A method performed at a client computing device, the method comprising:
receiving an application program package including an application program package binary file and an application program package manifest file;
installing the application program package in non-volatile memory at a file system location indicated in the application program package manifest file;
receiving a modification package including a modification package binary file and a modification package manifest file, wherein the modification package manifest file indicates the file system location of the application program package in the non-volatile memory;
installing the modification package in the non-volatile memory, wherein installing the modification package includes modifying at least one of the application program package binary file or the application program package manifest file based on at least one setting included in the modification package binary file;
executing the modified application program package binary file; and
executing the modification package binary file independently of the modified application program package binary file.

17. (canceled)

18. The method of claim 16, wherein at least one of the application program package and the modification package is received via a network from an application program store.

19. The method of claim 16, further comprising receiving an additional modification package including an additional modification package binary file and an additional modification package manifest file.

20. The method of claim 19, further comprising modifying at least one of the modified application program package binary file, the modified application program package manifest file, the modification package binary file, and the modification package manifest file based on at least one additional setting included in the additional modification package binary file.

21. The client computing device of claim 1, wherein installing the modification package includes modifying the application program package binary file and the application program package manifest file.

22. The server computing device of claim 11, wherein the modification package binary file includes one or more instructions to modify the application program package binary file and the application program package manifest file.

23. The method of claim 16, wherein installing the modification package includes modifying the application program package binary file and the application program package manifest file.
